(19) United States
(12) Patent Application Publication
(10) Pub. No.: US 2003/0019298 A1
(43) Pub. Date: Jan. 30, 2003

(54) Frost-resistant pressure sensor

(76) Inventors: Heiko Scheurich, Stuttgart (DE); Winfried Kuhnt, Stuttgart (DE); Martin Mast, Gerlingen (DE); Berthold Rogge, Stuttgart (DE); Masoud Habibi, Stuttgart (DE); Hanspeter Mayer, Adnet (AT)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/030,620

(22) PCT Filed: Apr. 19, 2001
(86) PCT No.: PCT/DE01/01506

(30) Foreign Application Priority Data
May 13, 2000 (DE) 100 23 589.1

(51) Int. Cl. G01L 7/08

(52) U.S. Cl. 73/715

(57) ABSTRACT

The current invention relates to a freeze-resistant pressure sensor, which is comprised of a pressure sensor housing (9), which encloses a pressure measurement chamber (10), and a pressure measurement cell (2). In addition, an elastically flexible compensation element (1) is provided, which is disposed in the pressure measurement chamber (10).

### PRIOR ART

The current invention relates to a pressure sensor and in particular, a freeze-resistant pressure sensor.

As a measurement and regulation engineering-related value, pressure is used in a multitude of applications that range from medical technology to automotive engineering. Correspondingly, there are numerous uses for pressure sensors.

The development of microelectronics and micromechanics since the 1970s has made it possible to inexpensively produce large quantities of pressure sensors that are miniaturized with the aid of silicon technology. However, pressure sensors of this kind are not stable under high pressures of the kind that occur when the pressure sensor is exposed to a pressure medium which expands volumetrically when it freezes, for example water.

WO-98/31997 gives one example of a freeze-resistant pressure sensor. In the pressure sensor disclosed there, a silicon chip is attached to a glass support. A glass support has an opening for the silicon chip. The glass support is fastened to a tubular support so that a continuous line is formed. The pressure medium remains in contact with the silicon chip via the line. A compressible insert is installed in the line. In this pressure sensor, it is disadvantageous that despite the compressible insert, it is possible for the pressure sensor to be damaged during freezing of the fluid because the compressible insert is only disposed in a partial section of the line and consequently, fluid disposed in the vicinity of the pressure measurement chamber and disposed after the compressible insert can freeze so that there is not enough expansion potential for the freezing fluid in the pressure measurement chamber and the pressure sensor can be damaged. It is also disadvantageous that the method for installation of the compressible insert is expensive. Furthermore, the compressible insert is subjected to high thermal stresses during the process of fastening the silicon chip to the glass support or of fastening the glass support to the tubular support, so that it has only a short service life and/or can be damaged during installation.

WO-98/20248 has also disclosed a sensor for measuring the absolute pressure in the intake manifold, which sensor has a housing and a cover. The cover is connected to the housing by means of numerous slots and correspondingly embodied protrusions in order to prevent a detachment of the cover from the housing and/or destruction of the connection between the two elements. However, such a design is not suitable for a freeze-resistant pressure sensor.

### ADVANTAGES OF THE INVENTION

The freeze-resistant pressure sensor to the invention, with the features of the main claim, has the advantage over the prior art that an elastically flexible compensation element is disposed in the pressure measurement chamber. This is assured by virtue of the fact that thanks to the presence of the elastically flexible compensation element in the pressure measurement chamber, the fluid in the pressure measurement chamber can expand when it freezes, without damaging or destroying a pressure measurement cell of the pressure sensor. With a normal application of pressure, i.e. when the fluid in the pressure measurement chamber is not frozen, the elastically flexible compensation element has no function. The pressure spreads out evenly until it reaches the pressure measurement cell. If the pressure medium then freezes, no excess pressure can occur or at most a very slight excess pressure can occur because the elastically flexible element yields to the volume expansion and consequently absorbs a volume expansion of the pressure medium. Therefore a damage to the pressure measurement cell and/or to the housing of the pressure sensor can be prevented.

Preferably, the elastically flexible compensation element itself has elastic properties. The elastically flexible element can, for example, be made of rubber or foam, or can be embodied as an elastically deformable diaphragm box.

Preferably, the elastically flexible compensation element is embodied as an elastic plate.

According to a preferred embodiment of the current invention, the elastically flexible compensation element is elastically supported. For example, it is possible that the elastic support is constituted by a plate that is elastically glued in place. In this connection, for example, a stationary plate inside the pressure sensor housing is fastened by means of an adhesive which has elastic properties even after hardening. In order to assure a sufficient flexibility of the elastically glued plate here, a hollow, gas-filled chamber that is capable of absorbing the volume increase should also be provided between the elastically glued plate and the housing wall.

Preferably, the elastically flexible compensation element is merely a plate supported by a spring. In this connection, the spring should have only a slight spring force in order to permit a sufficient expansion of the fluid when the pressure measurement chamber freezes.

According to another embodiment of the current invention, the elastically flexible compensation element is embodied as an elastic housing wall. This can be achieved, for example, by part of the housing wall having a lesser thickness than the rest of the housing wall. Consequently, a freeze-resistant pressure sensor can be produced in a particularly simple, inexpensive manner.

It is advantageous to embody the elastically flexible compensation element as an elastic plate integrated into the housing. The size of the elastic plate can be selected in accordance with the volume increase to be produced. Preferably, the medium disposed in the pressure sensor housing is water.

In order to assure an additional protection of the pressure measurement cell, it can be embodied, for example, using thick film technology. In addition, it is also possible for the pressure measurement cell to be provided with a protective layer.

According to the invention, it is also possible for the pressure sensor to be embodied, for example, as an absolute pressure sensor or also as a differential pressure sensor.

### DRAWINGS

Two exemplary embodiments of the current invention are shown in the drawings and will be explained in detail in the subsequent description.

FIG. 1 shows a cross section through a first exemplary embodiment of a freeze-resistant pressure sensor according to the invention and

FIG. 2 shows a cross section through a second exemplary embodiment of a freeze-resistant pressure sensor according to the invention.

### DESCRIPTION OF THE EXEMPLARY EMBODIMENTS

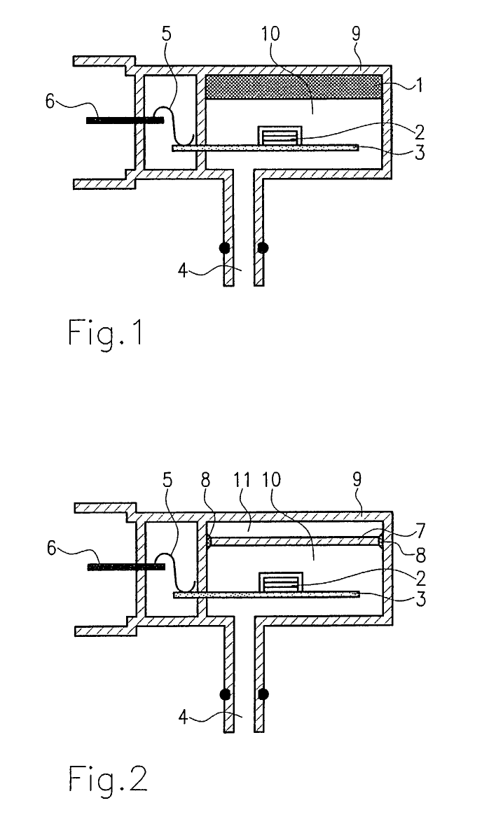

The design of the pressure sensors in FIGS. 1 and 2 is not shown to scale in order to permit better comprehension of the current invention.

FIG. 1 shows a first exemplary embodiment of a freeze-resistant pressure sensor according to the invention, according to the current invention. The pressure sensor is comprised of a housing 9, a pressure measurement cell 2 and a support plate 3. The measurement cell 2 is fastened to the support plate 3 and is disposed inside a pressure measurement chamber 10. In this instance, the support plate 3 is affixed to the housing 9. In addition, the pressure sensor according to the first exemplary embodiment has a pressure fitting 4, which communicates with the pressure measurement chamber 10 and which can be used to supply a pressure medium, e.g. urea, to the pressure measurement chamber 10.

In addition, an elastically flexible compensation element 1, e.g. made of rubber or a foam, is disposed in the pressure measurement chamber 10. As shown in FIG. 1, the elastically flexible compensation element 1 is attached directly to the wall of the housing 9, e.g. by means of adhesive. In this case, the pressure measurement cell 2 is disposed directly opposite from the elastically flexible compensation element 1. This is a particularly advantageous arrangement of the pressure measurement cell 2 and the elastically flexible compensation element 1 in relation to each other for the purpose of preventing damage to the pressure measurement cell 2.

In order to further process the pressures recorded by the pressure measurement cell 2, the support plate 3 is connected to a plug connector 6 via an electrical connection 5, via which the recorded values can be supplied, for example, to a set of control and/or evaluation electronics. In addition, the supply voltage and signal voltage are conveyed to or from the plug connector 6 via the electrical connection 5 of the support plate 3.

If the pressure medium in pressure measurement chamber 10 freezes, then the elastically flexible compensation element 1 yields and is compressed. As a result, the volume of the pressure measurement chamber 10 increases so that the expansion of the pressure medium due to the freezing can be compensated for. Therefore the pressure measurement cell 2 is not damaged when the pressure medium in the pressure measurement chamber 10 freezes. In this case, a very slight excess pressure in the pressure measurement chamber 10 can occur during the freezing, without the pressure measurement cell 2 being damaged.

FIG. 2 shows a second exemplary embodiment of a freeze-resistant pressure sensor according to the invention. Parts which are the same are provided with the same reference numerals as in the first exemplary embodiment.

In contrast to the freeze-resistant pressure sensor of the first exemplary embodiment, in the second exemplary embodiment, a plate 7 that is elastically glued in place is provided as the elastically flexible compensation element. The plate 7 is glued into an inner hollow chamber of the housing 9 in such a way that an additional hollow chamber 11 is produced in the housing 9 in addition to the pressure measurement chamber 10. In this instance, the plate 7 is glued into the housing 9 along its entire circumference by means of an adhesive that retains its elasticity even after hardening. This produces the hollow chamber 11, which is filled with a gas, e.g. air. The gluing process seals the hollow chamber 11 off from the pressure measurement chamber 10.

Consequently, in the second exemplary embodiment, the elastically flexible compensation element is comprised of the plate 7 and the elastic support 8, which is constituted by the adhesive.

If a pressure medium in the pressure measurement chamber 10 freezes, then the elastically glued plate 7, due to its elastic support, is moved slightly into the hollow chamber 11, as a result of which the volume of the hollow chamber 11 decreases. Since the hollow chamber 11 contains a gaseous medium, it is easily possible for this volume reduction to occur. As a result, the volume increase that occurs when the pressure medium in the pressure measurement chamber 10 freezes can be compensated for. Consequently, the pressure measurement cell 2 disposed in the pressure measurement chamber 10 is not damaged.

In summary, a freeze-resistant pressure sensor has been described that includes a pressure sensor housing 9, which contains a pressure measurement chamber 10, and a pressure measurement cell 2. In addition, an elastically flexible compensation element 1, 7, 8 is provided, which is disposed in the pressure measurement chamber 10.

The above description of exemplary embodiments according to the current invention is intended only for illustrative purposes and not for the purpose of limiting the invention. Within the scope of the invention, numerous changes and modifications are possible without going beyond the scope of the invention and its equivalents.

6. The freeze-resistant pressure sensor according to claim 5, characterized in that the elastically flexible compensation element is embodied as a plate (7) that is glued in place in an elastic fashion.

7. The freeze-resistant pressure sensor according to claim 5, characterized in that the elastically flexible compensation element is embodied as a plate supported by a spring.

8. The freeze-resistant pressure sensor according to claim 1, characterized in that the elastically flexible compensation element is embodied as an elastic housing wall.

9. The freeze-resistant pressure sensor according to claim 1, characterized in that the elastically flexible compensation element is embodied as an elastic plate integrated into the housing.

10. The freeze-resistant pressure sensor according to one of claims 1 to 9, characterized in that the pressure measurement cell (2) is embodied using thick-film technology or in that the pressure measurement cell (2) has a protective layer.
